(19) United States
(12) Patent Application Publication
(10) Pub. No.: US 2023/0387419 A1
(43) Pub. Date: Nov. 30, 2023

(54) STRETCHABLE CURRENT COLLECTOR AND LITHIUM SECONDARY BATTERY INCLUDING THE SAME

(71) Applicant: Jae-Kwang Kim, Cheongju-si (KR)

(72) Inventor: Jae-Kwang Kim, Cheongju-si (KR)

(21) Appl. No.: 17/897,830

(22) Filed: Aug. 29, 2022

(30) Foreign Application Priority Data
May 25, 2022 (KR) 10-2022-0064180

(51) Int. Cl. H01M 4/66; H01M 4/80

(52) U.S. Cl. CPC H01M 4/668; H01M 4/806; D01D 5/003

(57) ABSTRACT

The present disclosure relates to a current collector formed of nanofiber, which includes PEDOT:PSS and a conductive dopant, a lithium secondary battery electrode including the current collector, and a lithium secondary battery, and the current collector of the present disclosure is characterized in that excellent structural stability, mechanical properties, and electrical conductivity may be achieved by doping nanofiber prepared through electro-spinning with a conductive dopant. The present disclosure was created with the support for a sub-director enterprise support project from Chungbuk Innovation Institute of Science & Technology.

### CROSS-REFERENCE TO RELATED APPLICATION

This application claims priority to Korean Patent Application No. 10-2022-0064180 filed on May 25, 2022, and all the benefits accruing therefrom under 35 U.S.C. § 119, the contents of which are incorporated by reference in their entirety.

### BACKGROUND

The present disclosure relates to a current collector formed of nanofiber and thus having excellent stretch, flexibility, and electrical conductivity, a lithium secondary battery electrode including the current collector, a lithium secondary battery including the electrode, and a method of preparing the current collector.

Stretchable electronic devices are electronic device which have recently been highlighted by virtue of their variously modifiable characteristics supported by external stress, and the characteristics enable the stretchable electronic devices to be applicable to high-tech future industries such as wearable devices, electronic skin, and bio-integrated devices. Meanwhile, developing truly stretchable electronic devices require various parts included in the electronic devices to be stretchable, and it is particularly important to make sure that a battery itself used as a power source of the electronic devices is stretchable. However, the most widely used lithium secondary battery uses metals that are heavy and have low elastic strain such as copper, aluminum, and the like as a current collector in the battery, and that serves as a stumbling block in developing stretchable electronic devices with no replacement of the typical material.

Accordingly, as a way of developing stretchable electronic devices, studies are diversly conducted to develop stretchable current collectors that may replace the typical metal current collector, and thus for example, current collectors to which various stretchable structures such as a wave structure, a buckle structure, and a serpentine structure are applied have been developed. However, the structures described above are not desirable since their structural characteristics cause non-uniform stretch and greater difficulty in manufacturing processes for implementing a complex form makes the structures non-cost effective. Therefore, there remains a need for further research on stretchable current collectors that are uniformly stretchable, have excellent electrical conductivity, and are manufacturable through a simple manufacturing process.

Meanwhile, studies have been conducted in various ways to use carbon-based materials such as graphene or carbon nanotubes or conductive polymers, which are lightweight and have excellent electrical conductivity, for stretchable current collectors, and among them, there is a previous study that has succeeded in manufacturing a lightweight and flexible current collector using a conductive polymer film such as PEDOT:PSS as a current collector substrate. However, the PEDOT:PSS film shows exceptionally low electrical conductivity (about 1 S/m) versus the typical metal current collector, and efforts have been made to improve electrical conductivity by adding various components to the film to overcome the obstacle.

In line with this point of view, the present inventors have found out that both stretch and electrical conductivity may be achievable when PEDOT:PSS is used and manufactured in the form of nanofiber through electro-spinning, and a current collector is manufactured by doping the nanofiber with a conductive dopant to complete the present disclosure regarding a current collector having excellent both stretch and electrical conductivity.

### SUMMARY

The present disclosure provides a current collector having both excellent stretch and excellent electrical conductivity, a lithium secondary battery electrode including the current collector, a lithium secondary battery including the electrode, and a method of preparing the current collector.

Aspects of the present disclosure are not limited to the above-described aspects, and other tasks and benefits of the present disclosure which are not described may be appreciated from the following descriptions, and more clearly appreciated from embodiment of the present disclosure. Further, it will be easily appreciated that the aspects and benefits of the present disclosure may be practiced by features recited in the appended claims and a combination thereof.

The present disclosure is to resolve the tasks described above, and in accordance with an exemplary embodiment of the present disclosure, a current collector formed of nanofiber includes PEDOT:PSS and a conductive dopant.

In accordance with another exemplary embodiment of the present disclosure, a lithium secondary battery electrode includes the current collector and a positive electrode active material or a negative electrode active material, which is formed on a surface of the current collector.

In accordance with another exemplary embodiment of the present disclosure, a lithium secondary battery includes the electrode, a separator, and an electrolyte.

In accordance with still another exemplary embodiment of the present disclosure, a method of preparing a current collector includes a process (S1) of adding a PEDOT:PSS solution to a polymer polymerization solution to obtain an electro-spinning solution, a process (S2) of electro-spinning the electro-spinning solution to obtain nanofiber, and a process (S3) of doping the nanofiber with a conductive dopant.

### BRIEF DESCRIPTION OF THE DRAWINGS

Exemplary embodiments can be understood in more detail from the following description taken in conjunction with the accompanying drawings, in which:

FIG. 1(a) and FIG. 1(b) show results of observing microstructures of current collectors obtained in Example and Comparative Example through Tapping Mode of Atomic Force Microscope (AFM);

FIG. 2 shows results of examining crystal structures of current collectors obtained in Example and Comparative Example through X-ray diffraction analysis (XRD, Bruker AXS, D8 Discover with GADDS, Cu-kα radiation (λ=1.5418 Å));

FIG. 3(a), FIG. 3(b) and FIG. 3(c) show results of observing surface shapes of current collectors obtained in Example and Comparative Example through FE-SEM;

FIG. 4 shows results of measuring surface resistance and electrical conductivity of current collectors obtained in Example and Comparative Example;

FIG. 5(a), FIG. 5(b) and FIG. 5(c) show results of examining appearance and stretching characteristics of current collectors obtained in Example and Comparative Example;

FIG. 6 shows results of observing an initial charge-discharge profile of an LFP-Li half-cell including a current collector of Example;

FIG. 7 is shows results of measuring a CV curve up to 50 cycles of an LFP-Li half-cell including a current collector of Example;

FIG. 8 shows a discharge capacity measured while increasing the current rate stepwise from 0.1 C to 5.0 C for an LFP-Li half-cell including a current collector of Example; and

FIG. 9 shows results of examining the capacity retention rate for an LFP-Li half-cell including a current collector of Example.

### DETAILED DESCRIPTION OF EMBODIMENTS

Hereinafter, principles of preferred embodiments of the present disclosure will be described in detail with reference to the accompanying drawings and descriptions. However, the drawings shown below and the following descriptions are for preferred methods among various methods, for effectively describing characteristics of the present disclosure, and the present disclosure is not limited only to the following drawings and descriptions.

Meanwhile, although terms such as first, second, and the like may be used herein to describe various elements, these terms are used merely to distinguish one element from another element. For example, a first element may be referred to as a second element, and similarly, a second element may be referred to as a first element.

The singular forms are intended to include the plural forms as well, unless the context clearly indicates otherwise. As used herein, it should be understood that the terms “comprise” or “have” are intended to specify the presence of stated features, integers, processes, operations, elements, components, or combinations thereof, but do not preclude the presence or addition of one or more other features, integers, processes, operations, elements, components, or combinations thereof.

Unless defined otherwise, all the terms used herein, including technical or scientific terms, may have the same meanings as those commonly understood by those skilled in the art. Terms that are defined in a commonly used dictionary should be construed as having meanings consistent with the meanings in the context of the related art, and should meaning not be construed as having an ideal or overly formal meaning unless explicitly defined herein.

The present disclosure provides a current collector formed of nanofiber, which includes PEDOT:PSS and a conductive dopant.

In this case, PEDOT:PSS indicates poly(3,4-ethylenedioxythiophene):poly(styrenesulfonate) and refers to a polymer mixture in which PEDOT and PSS are mixed. PEDOT:PSS is known as a polymer plastic material having electrical conductivity, and has excellent stability, processability, and flexibility.

The PEDOT:PSS may be prepared by mixing an aqueous solution of PSS with an EDOT monomer, and the PEDOT:PSS used in the present disclosure is not particularly limited in its preparation method.

The PEDOT:PSS may vary in a molar ratio between PEDOT and PSS, which are mixed, and depending on the molar ratio, the PEDOT:PSS may have different properties. In the PEDOT:PSS used in the present disclosure, the molar ratio between PEDOT and PSS may be 1:0.5 to 1:5, preferably 1:1 to 1:4, and particularly preferably 1:2 to 1:3. When the molar ratio between PEDOT and PSS is within the above range, the PEDOT:PSS has excellent conductivity, stability, and flexibility and may thus exhibit excellent performance when used as a current collector.

In the current collector provided from the present disclosure, the nanofiber may be porous. As in the following descriptions, the current collector may be prepared through electro-spinning, and accordingly, the nanofiber of the current collector provided from the present disclosure may have porosity, which is a nanofiber characteristic obtained through electro-spinning.

When the nanofiber has porosity, a nanofiber structure may be doped with a conductive dopant in a highly efficient manner, thereby greatly improving electrical conductivity of the current collector itself. In addition, as the current collector has improved wettability with respect to an electrolyte, resistance to movement of lithium ions is reduced, and thus it is believed to improve overall performance of a lithium secondary battery.

Meanwhile, the nanofiber may have an average diameter of 50 μm to 300 μm, and preferably 100 μm to 200 μm. The nanofiber is obtained through electro-spinning, and thus have a small thickness as described above, and also has uniform diameter distribution. When the diameter of the fiber is thin and the distribution thereof is uniform as above, the weight of the current collector itself may be easily reduced, the mechanical strength of the current collector itself may be maintained high, and the flexibility of the current collector is excellent. In addition, the weight reduction of the current collector itself may lead to an increase in energy density of a lithium secondary battery.

In the current collector of the present disclosure, the nanofiber may include at least one polymer selected from the group consisting of polyacrylonitrile, polyethylene oxide, polyvinylpyrrolidone, polyacrylamide, polyetheramide, polymethylmethacrylate, polycarbonate, polyurethane, polyvinyl chloride, polyethylene terephthalate, polyamide, polysulfone, polyether sulfone, polyphenylene sulfone, polyvinyl acetate, polyacrylic acid, polyvinyl alcohol, polyvinylidene fluoride, polyimide, polystyrene, polycarpolactone, polycaprolactam, polylactic acid, polylacticcoglycolic acid, polyhydroxyalkanoate, collagen, gelatin, chitosan, chitin, cellulose, hydroxyethyl cellulose, methyl cellulose, and ethyl cellulose, and may preferably include polyacrylamide. PEDOT:PSS has poor rheological properties such as low viscosity, and thus the PEDOT:PSS alone is hardly prepared in the form of fiber through electro-spinning. For the reason above, applying PEDOT:PSS to electro-spinning requires a proper carrier polymer, and the polymers listed above may be applied as the carrier polymer. In particular, when polyacrylamide is used as the carrier polymer, the nanofiber has excellent mechanical properties and excellent stretch, which may be particularly helpful for weaving the nanofiber in the form of fabric upon electro-spinning.

In the current collector of the present disclosure, the conductive dopant may be at least one selected from the group consisting of dimethyl sulfoxide (DMSO), dimethylformamide (DMF), ethylene glycol (EG), glycerol, and sorbitol, and the conductive dopant may be preferably DMSO. Although PEDOT:PSS has conductivity, the conductivity is significantly lower than that of a metal commonly used as a current collector in a typical electrode. Therefore, in the present disclosure, the nanofiber is doped with the conductive dopant described above and thus has greatly improved electrical conductivity. In particular, when the nanofiber is doped with DMSO, the electrical conductivity thereof may be significantly improved. The nanofiber may be doped with the conductive dopant in a highly efficient manner due to the above-described porous structure.

Lithium Secondary Battery Electrode

The present disclosure provides a lithium secondary battery electrode including the current collector described above, and specifically provides a lithium secondary battery electrode including the current collector and a positive electrode active material or a negative electrode active material, which is formed on a surface of the current collector.

As described above, the current collector has excellent stretch and electrical conductivity, excellent structural and electrochemical stability, and is lightweight itself, and may thus be used as a current collector of the lithium secondary battery electrode. The electrode to which the current collector is applied may be a positive electrode or a negative electrode depending on the type of an active material formed on the surface of the current collector, and the type of the positive electrode active material or the negative active material is not particularly limited.

Positive Electrode

When the active material formed on the current collector is a positive electrode active material, the electrode for a lithium secondary battery may be a positive electrode. The positive electrode may be prepared by forming a positive electrode material mixture layer on a positive electrode collector. The positive electrode material mixture layer may be formed by coating the positive electrode collector with a positive electrode slurry including a positive electrode active material, a binder, a conductive agent, and a solvent, and then drying and rolling the coated positive electrode collector.

To be specific, the positive electrode active material is a compound reversibly intercalating and deintercalating lithium or sodium, and may include at least one selected from the group consisting of lithium-cobalt-based oxide, sodium-cobalt-based oxide, lithium-manganese-based oxide, sodium-manganese-based oxide, lithium-nickel-manganese-based oxide, sodium-nickel-based oxide, lithium-manganese-cobalt-based oxide, sodium-manganese-cobalt-based oxide, lithium-nickel-manganese-cobalt-based oxide, sodium-nickel-manganese-cobalt-based oxide, lithium-nickel-cobalt-aluminum-based oxide, sodium-nickel-cobalt-based oxide, lithium-nickel-cobalt-manganese-aluminum-based oxide, sodium-nickel-cobalt-manganese-aluminum oxide, lithium iron phosphate oxide, sodium iron phosphate oxide, and a lithium-sulfur compound. To be more specific, for example, the positive electrode active material may be LiMnO₂, LiMn₂O₄, LiNi_{1-Y}Mn_{Y}O₂ (0<Y<1), LiMn_{2-z}Ni_{z}O₄ (0<Z<2), LiNi₁—Y1Co_{Y1}O₂ (0<Y1<1), LiCo_{1-Y2}Mn_{Y2}O₂ (0<Y2<1), LiMn_{2-z1}Co_{z1}O₄ (0<Z1<2), Li(NiₚCo_{q}Mnᵣ₁)O₂ (0<p<1, 0<q<1, 0<r1<1, and p+q+r1=1), Li(Niₚ₁Co_{q1}Mnᵣ₂)O₄ (0<p1<2, 0<q1<2, 0<r2<2, and p1+q1+r2=2), Li(Ni_{g}CoₕMnᵢ)O₂ (where g, h, and j are atomic fractions of each independent elements, wherein 0<g<1, 0<h<1, 0<j<1, and g+h+j=1), Li(NiₖCoₗMnₘ)O₄ (where k, l, and m are atomic fractions of each independent elements, wherein 0<k<2, 0<1<2, 0<m<2, and k+l+m=2), Li(NiₙCoₚAl_{q})O₂ (where n, p, and q are atomic fractions of each independent elements, wherein 0<n<1, 0<p<1, 0<q<1, and n+p+q=2), LiFePO₄, NaMn₂O₄, NaNiO₂, NaCoO₂, NaFeO₂, inorganic sulfur, Li₂Sn (n≥1), a disulfide compound, an organic sulfur compound, and a carbon-sulfur polymer.

The positive electrode active material may be included in an amount of 90 wt % to 99 wt %, specifically, 93 wt % to 99 wt %, with respect to a total weight of solid content in the positive electrode slurry.

The binder is a component that assists in the binding between the active material and the conductive agent and in the binding with the current collector, and is commonly added in an amount of 1 wt % to 30 wt % with respect to the total weight of the solid content in the positive electrode slurry. Examples of the binder may be polyvinylidene fluoride (PVDF), polyvinyl alcohol, carboxymethylcellulose (CMC), starch, hydroxypropylcellulose, regenerated cellulose, polyvinylpyrrolidone, tetrafluoroethylene, polyethylene, polypropylene, an ethylene-propylene-diene terpolymer, a sulfonated-ethylene-propylene-diene terpolymer, a styrene-butadiene rubber, a fluoro rubber, various copolymers, and the like.

Such conductive agent is not particularly limited as long as it has conductivity without causing chemical changes in the battery, and for example, a conductive material, such as: carbon powder such as carbon black, acetylene black, Ketjen black, channel black, furnace black, lamp black, or thermal black; graphite powder such as natural graphite with a well-developed crystal structure, artificial graphite, or graphite; conductive fibers such as carbon fibers or metal fibers; metal powder such as fluorocarbon powder, aluminum powder, and nickel powder; conductive whiskers such as zinc oxide whiskers and potassium titanate whiskers; conductive metal oxide such as titanium oxide; polyphenylene derivatives, or the like may be used.

The conductive agent is commonly added in an amount of 0.5 wt % to 20 wt % with respect to the total weight of the solid content in the positive electrode slurry.

The solvent may include an organic solvent, such as NMP, and may be used in an amount such that desirable viscosity is obtained when the positive electrode active material as well as selectively the binder and the conductive agent are included. For example, the solvent may be included in an amount such that a concentration of the solid content in the slurry including the positive electrode active material as well as selectively the binder and the conductive agent is 30 wt % to 90 wt %, and preferably 40 wt % to 80 wt %.

Negative Electrode

When the active material formed on the current collector is a negative electrode active material, the electrode for a lithium secondary battery may be a negative electrode. The negative electrode may be prepared by forming a negative electrode material mixture layer on a negative electrode collector. The negative electrode material mixture layer may be formed by coating the negative electrode collector with a slurry including a negative electrode active material, a binder, a conductive agent, and a solvent, and then drying and rolling the coated negative electrode collector.

To be specific, the negative electrode active material may include at least one selected from the group consisting of lithium metal, a carbon material capable of reversibly intercalating/deintercalating lithium ions, metals or alloys of lithium and these metals, a metal composite oxide, a material which may be doped and undoped with lithium, and a transition metal oxide.

To be more specific, as the carbon material capable of reversibly intercalating/deintercalating lithium ions, any carbon material may be used without particular limitation so long as it is a carbon-based negative electrode active material generally used in a lithium ion secondary battery, and, as a typical example, crystalline carbon, amorphous carbon, or both thereof may be used. Examples of the crystalline carbon may be graphite such as irregular, planar, flaky, spherical, or fibrous natural graphite or artificial graphite, and examples of the amorphous carbon may be soft carbon (low-temperature fired carbon) or hard carbon, mesophase pitch carbide, and fired cokes.

As the metals or alloys of lithium and these metals, metals selected from the group consisting of Cu, Ni, Na, K, Rb, Cs, Fr, Be, Mg, Ca, Sr, Si, Sb, Pb, In, Zn, Ba, Ra, Ge, Al, and Sn or alloys of lithium and these metals may be used.

One selected from the group consisting of PbO, PbO₂, Pb₂O₃, Pb₃O₄, Sb₂O₃, Sb₂O₄, Sb₂O₅, GeO, GeO₂, Bi₂O₃, Bi₂O₄, Bi₂O₅, LiₓFe₂O₃ (0≤x≤1), LiₓWO₂ (0≤x≤1), and SnₓMe₁₋ₓMe′_{y}O_{z} (Me:Mn, Fe, Pb, or Ge; Me′:Al, boron (B), P, Si, Groups I, II, and III elements of the periodic table, or halogen; 0≤x≤1; 1≤y≤3; 1≤z≤8) may be used as the metal oxide.

The material, which may be doped and undoped with lithium, may include Si, SiOₓ (0≤x≤2), a Si—Y alloy (where Y is an element selected from the group consisting of alkali metal, alkaline earth metal, a Group 13 element, a Group 14 element, transition metal, a rare earth element, and a combination thereof, and is not Si), Sn, SnO₂, and Sn—Y (where Y is an element selected from the group consisting of alkali metal, alkaline earth metal, a Group 13 element, a Group 14 element, transition metal, a rare earth element, and a combination thereof, and is not Sn), and a mixture of SiO₂ and at least one thereof may also be used. The element Y may be selected from the group consisting of Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and a combination thereof.

The transition metal oxide may include lithium-containing titanium composite oxide (LTO), vanadium oxide, and lithium vanadium oxide.

The negative electrode active material may be included in an amount of 80 wt % to 99 wt % with respect to a total weight of solid content in the negative electrode active material slurry.

The binder is a component that assists in the binding between the conductive agent, the active material, and the current collector, and is commonly added in an amount of 1 wt % to 30 wt % with respect to the total weight of the solid content in the negative electrode active material slurry. Examples of the binder may be polyvinylidene fluoride (PVDF), polyvinyl alcohol, carboxymethylcellulose (CMC), starch, hydroxypropylcellulose, regenerated cellulose, polyvinylpyrrolidone, tetrafluoroethylene, polyethylene, polypropylene, an ethylene-propylene-diene polymer, a sulfonated-ethylene-propylene-diene-terpolymer, a styrene-butadiene rubber, a fluoro rubber, and various copolymers thereof.

The conductive agent is a component for further improving the conductivity of the negative electrode active material, and may be added in an amount of 1 wt % to 20 wt % with respect to the total weight of the solid content in the negative electrode active material slurry. Such conductive agent is not particularly limited as long as it has conductivity without causing chemical changes in the battery, and for example, a conductive material, such as: graphite such as natural graphite and artificial graphite; carbon black such as acetylene black, Ketjen black, channel black, furnace black, lamp black, and thermal black; conductive fibers such as carbon fibers and metal fibers; conductive powder such as carbon fluoride powder, aluminum powder, and nickel powder; conductive whiskers such as zinc oxide whiskers and potassium titanate whiskers; conductive metal oxide such as titanium oxide; or polyphenylene derivatives, or the like may be used.

The solvent may include water or an organic solvent, such as NMP and alcohol, and may be used in an amount such that desirable viscosity is obtained when the negative electrode active material as well as selectively the binder and the conductive agent are included. For example, the solvent may be included in an amount such that a concentration of the solid content in the slurry including the negative electrode active material as well as selectively the binder and the conductive agent is 30 wt % to 75 wt %, and preferably 40 wt % to 65 wt %.

Lithium Secondary Battery

The present disclosure provides a lithium secondary battery including the electrode described above, a separator, and an electrolyte.

The above-described electrode may be a positive electrode or a negative electrode, and an opposite electrode may be included in the lithium secondary battery according to the type of the above-described electrode.

As the separator, an organic separator or an organic and inorganic material composite separator may be used.

A porous polymer film prepared from a polyolefin-based polymer such as an ethylene homopolymer, a propylene homopolymer, an ethylene/butene copolymer, an ethylene/hexene copolymer, and an ethylene/methacrylate copolymer may be used alone or in a lamination therewith as the organic separator. In addition, a typical porous nonwoven fabric, for example, a nonwoven fabric formed of high melting point glass fibers or polyethylene terephthalate fibers may be used.

Porous organic and inorganic material composite safety-reinforcing separators (SRS) coated with a porous coating layer containing inorganic particles and binder polymers on the porous polyolefin-based separator base material may be used as the organic and inorganic material composite separators.

Using inorganic particles having lithium ion transfer ability or a mixture thereof as the inorganic particles is preferable, and typical examples of the inorganic particles may be a single material selected from the group consisting of BaTiO₃, Pb(Zr,Ti)O₃ (PZT), Pb₁₋ₓLaₓZr_{1-y}Ti_{y}O₃ (PLZT, where 0<x<1, 0<y<1), hafnia (HfO₂), SrTiO₃, SnO₂, CeO₂, MgO, NiO, CaO, ZnO, ZrO₂, Y2O₃, Al₂O₃, TiO₂, SiC, and a mixture thereof, or a mixture of two or more thereof.

The electrolyte may be an organic liquid electrolyte, an inorganic liquid electrolyte, a solid polymer electrolyte, a gel-type polymer electrolyte, a solid inorganic electrolyte, a molten-type inorganic electrolyte, and the like, but is not limited thereto.

Specifically, the electrolyte may include an organic solvent and a lithium salt.

Any organic solvent may be used without particular limitation as long as it may serve as a medium through which ions involved in an electrochemical reaction of a battery may move. Specifically, as the organic solvent, an ester-based solvent such as methyl acetate, ethyl acetate, γ-butyrolactone, and ε-caprolactone; an ether-based solvent such as dibutyl ether or tetrahydrofuran; a ketone-based solvent such as cyclohexanone; an aromatic hydrocarbon-based solvent such as benzene and fluorobenzene; a carbonate-based solvent such as dimethyl carbonate (DMC), diethyl carbonate (DEC), methylethyl carbonate (MEC), ethylmethyl carbonate (EMC), ethylene carbonate (EC), and propylene carbonate (PC); an alcohol-based solvent such as ethyl alcohol and isopropyl alcohol; nitriles such as R—CN (where R is a linear, branched, or cyclic C2 to C20 hydrocarbon group and may include a double-bond aromatic ring or ether bond); amides such as dimethylformamide; dioxolanes such as 1,3-dioxolane; or sulfolanes may be used. Among these solvents, a carbonate-based solvent is preferable, and a mixture of a cyclic carbonate (e.g., ethylene carbonate or propylene carbonate) having a high ionic conductivity and a high dielectric constant and a linear carbonate-based compound having a low viscosity (e.g., ethylmethyl carbonate, dimethyl carbonate, or diethyl carbonate), the mixture which may increase charging/discharging performance of a battery, is more preferable. In this case, the performance of the electrolyte solution may be excellent when the cyclic carbonate and the chain carbonate are mixed in a volume ratio of about 1:1 to about 1:9.

Any compound may be used as the lithium salt without particular limitation as long as it may provide lithium ions used in a lithium secondary battery. To be specific, an anion of the lithium salt may be at least one selected from the group consisting of F—, Cl—, Br—, I—, NO₃—, N(CN)₂—, BF₄—, CF₃CF₂SO₃—, (CF₃SO₂)₂N—, (FSO₂)₂N—, CF₃CF₂(CF₃)₂CO—, (CF₃SO₂)₂CH—, (SF₅)₃C—, (CF₃SO₂)₃C—, CF₃(CF₂)₇SO₃—, CF₃CO₂—, CH₃CO₂—, SCN—, and (CF₃CF₂SO₂)₂N—, and as the lithium salt, LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂. LiCl, LiI, or LiB(C₂O₄)₂ may be used. The lithium salt may be used in a concentration range of 0.1 M to 2.0 M. When the concentration of the lithium salt is in the above range, the electrolyte has suitable conductivity and viscosity, thereby exhibiting excellent performance, and lithium ions may effectively move.

In the electrolyte, in order to improve the lifespan properties of a battery, suppress the decrease in battery capacity, and improve the discharge capacity of the battery, one or more kinds of additives, for example, a halo-alkylene carbonate-based compound such as difluoroethylene carbonate, pyridine, triethylphosphite, triethanolamine, cyclic ether, ethylenediamine, n-glyme, hexaphosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride may be further included. In this case, the additive may be included in an amount of 0.1 wt % to 5 wt % with respect to a total weight of the electrolyte.

Preparation Method

The present disclosure provides a method of preparing the above-described current collector.

Specifically, the present disclosure provides a method of preparing a current collector, which includes a process (S1) of adding a PEDOT:PSS solution to a polymer polymerization solution to obtain an electro-spinning solution, a process (S2) of electro-spinning the electro-spinning solution to obtain nanofiber, and a process (S3) of doping the nanofiber with a conductive dopant.

As described above, the current collector of the present disclosure is prepared through electro-spinning, and the polymer polymerization solution in the process (S1) may be the polymerization solution of the carrier polymer described above. The process (S1) may be performed with stirring for more uniform mixing.

The electro-spinning in the process (S2) may be performed through a typical electro-spinning facility, and is not particularly limited. The electro-spinning conditions in the process (S2) are also not particularly limited, and the electro-spinning may be performed under typical conditions. For example, the electro-spinning may be performed at a voltage of 5 kV to 40 kV, a spray rate of 0.01 mL/h to 5 mL/h, a collector rotation speed of 100 rpm to 1000 rpm, and a temperature of 10° C. to 50° C., and may be performed under conditions outside the above-described ranges, if necessary.

Thereafter, the nanofiber obtained through the process (S2) may be doped with a conductive dopant (S3). The process (S3) may be performed by immersing the obtained nanofiber in a solution containing the conductive dopant described above.

Meanwhile, in the current collector preparation method of the present disclosure, the process (S4) of heat-treating the nanofibers obtained in the process (S2) may be further included. The heat-treating of the obtained nanofiber before doping with a conductive dopant may improve bonding strength between the carrier polymer and PEDOT:PSS. The heat-treating may be performed at 70° C. or higher, preferably at 100° C. to 150° C. for 6 hours or more, preferably 12 hours to 36 hours.

Hereinafter, the present disclosure will be described in more detail with reference to the following Examples. However, the following Examples are presented only for describing the present disclosure as an example, and the scope of the present disclosure is not limited thereto.

### Example

In 10 ml of acrylamide solution having a concentration of 1 M, 44.5 mL of APS having a concentration of 0.2 M (ammonium persulfate, 98%, Sigma Aldrich) was added as an initiator, and 3.78 mL of tetramethylethylenediamine (TEMED, 99%, Sigma Aldrich) was added as an accelerator to polymerize polyacrylamide with stirring at 70° C. for 3 hours. 12.31 mL of PEDOT:PSS solution having a wt % of 1.3 (manufacturer: Clevios, product name: PH1000) was added to the polymerization solution after polymerization, and the mixture was stirred for 18 hours. The stirred solution was put into an electro-spinning facility, and electro-spinning was performed at a voltage of 20 kV, a spraying speed of 0.5 mL/h, a collector rotation speed of 400 rpm, a distance between the tip and the collector of 16 cm, and room temperature. The nanofiber obtained through electro-spinning was heat-treated at 120° C. for 24 hours, and after the heat-treating, the nanofiber was immersed in DMSO organic solvent as a conductive dopant and doped to obtain a current collector.

### Comparative Example

A current collector was obtained in the same manner as in the above Example, except that DMSO was not used for doping.

### Experimental Example 1. Analysis of Microstructure of Current Collector

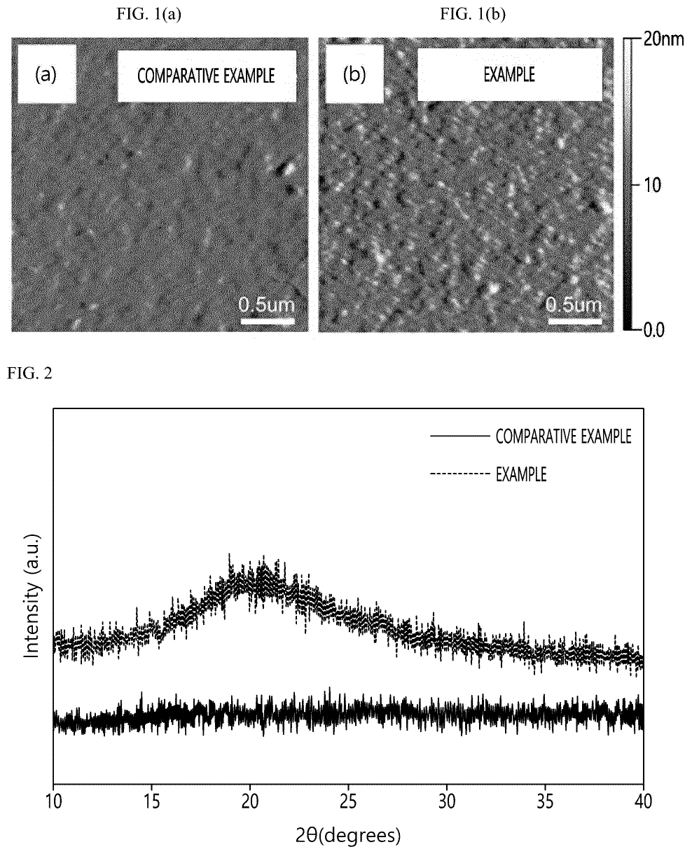

The microstructures of the current collectors obtained in Example and Comparative Example were observed through Tapping Mode of Atomic Force Microscope (AFM). The results are shown in FIG. 1.

In FIG. 1, the bright portion indicates a PEDOT-rich region, and the dark portion indicates a PSS region. As seen in FIG. 1, it was confirmed that an area of the PEDOT-rich region was increased in the case of Example by the hydrogen bond formed between the sulfonic acid group of PEDOT:PSS and the polar group (SO, SCH3) of DMSO, and mobility of charge carriers is improved due to reduced charge transport barrier, and accordingly, it is expected that electron conductivity of Example is higher than that of Comparative Example.

### Experimental Example 2. Analysis of Crystal Structure of Current Collector

The crystal structures of the current collectors obtained in Example and Comparative Example were examined through X-ray diffraction analysis (XRD, Bruker AXS, D8 Discover with GADDS, Cu-kα radiation (λ=1.5418)). The observed XRD pattern is shown in FIG. 2.

Comparative Example in which DMSO was not used for doping showed little crystallinity, and Example in which DMSO was used for doping showed a peak at about 20°, and it was confirmed that the crystallinity of the PEDOT-rich region was improved.

### Experimental Example 3. Analysis of Surface Shape of Current Collector

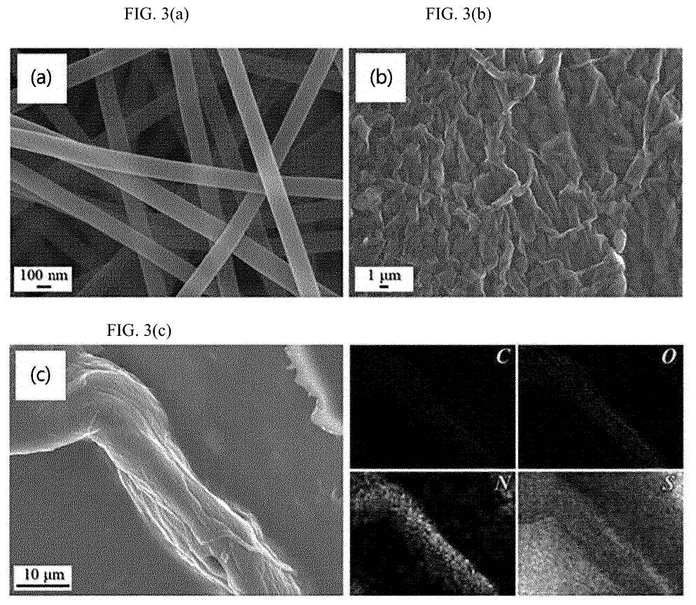

The surface shapes of the current collectors obtained in Example and Comparative Example were observed through FE-SEM, and the results are shown in FIG. 3.

The surface shape of the current collector obtained in Comparative Example is shown in FIG. 3 (a), and it is seen that nanofiber formed of the current collector of Comparative Example has an average diameter of about 100 μm to 200 μm and is uniform, and the distribution of PEDOT:PSS in the fiber is also uniform. From this, it is confirmed that when PEDOT:PSS and polyacrylamide are fiberized together through electro-spinning, nanofiber having a small diameter and uniform diameter distribution is obtainable.

The surface shape of the current collector obtained in Example is shown in FIG. 3 (b), and due to DMSO used for doping, electrical bonding force between PEDOT and PSS is reduced in PEDOT:PSS, and conductive passage through the PEDOT-rich region is formed, and accordingly, it is expected that the electrical conductivity of the current collector may be greatly improved. In addition, an element mapping image for the current collector obtained in Example is shown in FIG. 3 (c), and it is seen that PEDOT:PSS and DMSO were uniformly distributed in the nanofiber of the current collector through C, N, O, and S elements.

### Experimental Example 4. Examination of Electrical Characteristics of Current Collector

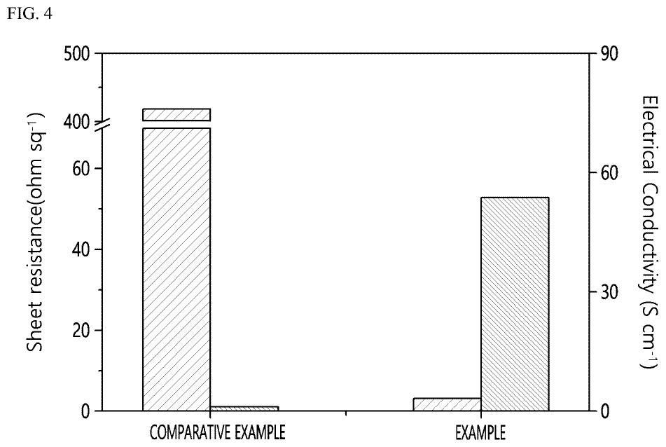

Surface resistance and electrical conductivity of the current collectors obtained in Example and Comparative Example were measured, and the results are shown in FIG. 4.

As seen in FIG. 4, Comparative Example exhibited a high surface resistance of about 420Ω, whereas Example exhibited a low surface resistance of about 3.15Ω. This is a difference of about 133 times, and it is seen that the area of the PEDOT-rich region increased through DMSO doping and the bonding force between PEDOT and PSS was reduced, resulting in reduced resistance. The electrical conductivity of Comparative Example is also about 1 S/cm, whereas the electrical conductivity of Example is about 52.89 S/cm, confirming that the electrical conductivity of Example is 50 times or more superior to that of the Comparative Example.

### Experimental Example 5. Appearance and Stretching Characteristics of Current Collector

The appearance and stretching characteristics of the current collectors obtained in Example and Comparative Example were examined, and the results are shown in FIG. 5.

FIG. 5 (a) is an observation of the current collector of Comparative Example, and FIG. 5 (b) is an observation of the current collector of Example. It is seen that through the DMSO doping process, an overall fiber area decreased and became flexible, and as seen through FIG. 5 (c) showing the stretching results of Example, the current collector of Example subjected to DMSO doping did not tear or decompose even when stretched to 30% or more, confirming high mechanical strength and stretch thereof.

### Experimental Example 6. Evaluation of Electrochemical Performance of Current Collector

A stretchable electrode was prepared using the current collector obtained in the above Example, and the electrochemical performance of the current collector was evaluated using the prepared electrode. After preparing a stretchable positive electrode using LiFePO₄ (LFP) as a positive electrode active material, electrochemical performance was evaluated with respect to an LFP-Li half-cell.

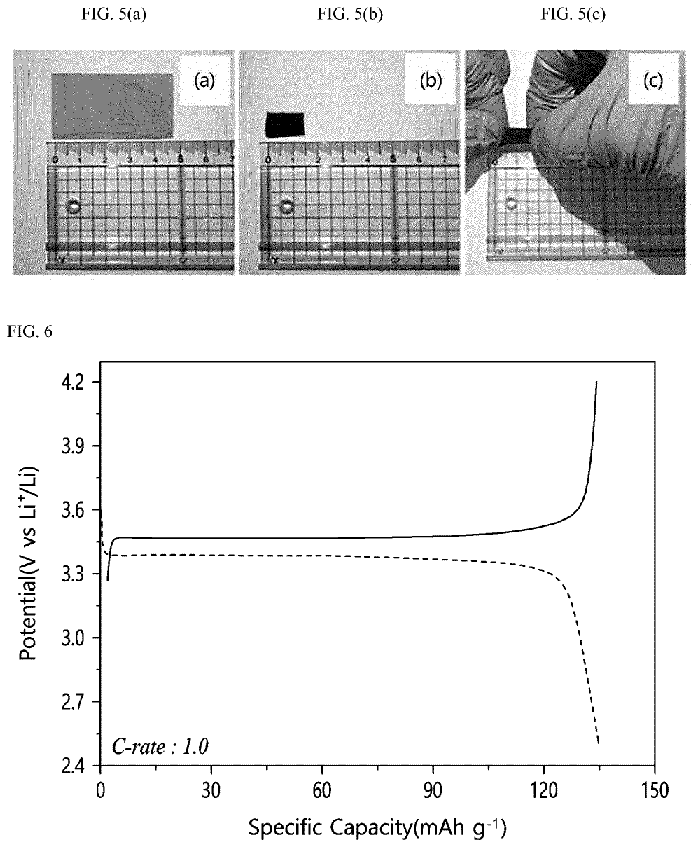

First, initial charge-discharge profile at a current density of 0.1 C-rate was examined and shown in FIG. 6. As seen in FIG. 6, both of the charging and discharging capacities exhibited the same value of 135 mAh/g, confirming that reversibility was remarkably high.

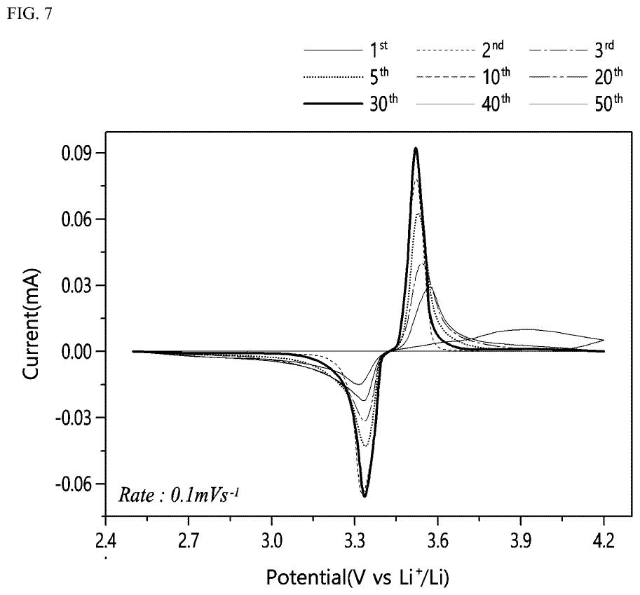

In addition, a cyclic voltammetry (CV) curve was measured up to 50 cycles at a rate of 0.1 mV/s, and is shown in FIG. 7. As seen in FIG. 7, oxidation peaks and reduction peaks were shown at about 3.5 V and 3.35 V, respectively, and as the oxidation peaks and reduction peaks increased up to 40 cycles, stabilization and a decrease in resistance in a battery were observed, and stable peaks were shown up to 50 cycles.

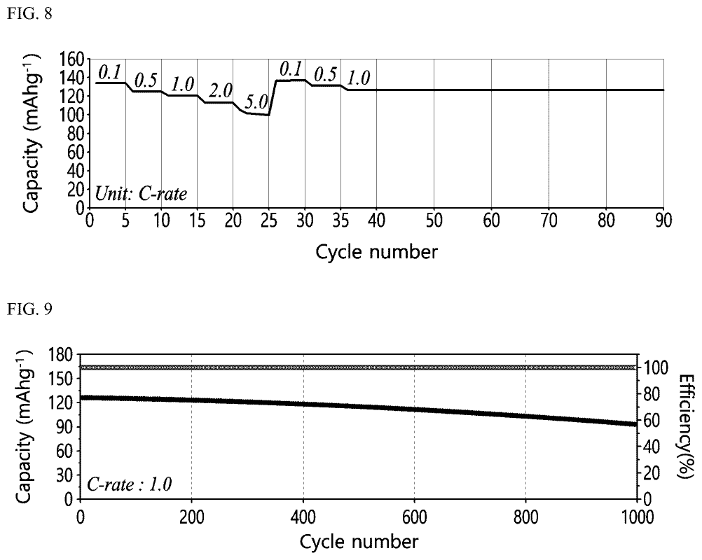

In addition, the discharge capacity was measured while increasing the current rate stepwise from 0.1 C-rate to 5.0 C-rate, and each step was repeated for 5 cycles. The results are shown in FIG. 8. The discharge capacities at 0.1 C-rate, 0.5 C-rate, 1.0 C-rate, 2.0 C-rate, and 5.0 C-rate were 134.9 mAh/g, 125.7 mAh/g, 120.8 mAh/g, 114.8 mAh/g, and 105.2 mAh/g, respectively, and when the rate was returned from 5.0 C-rate to 0.1 C-rate, the capacity was confirmed to be 137.1 mAh/g. Since the capacities were mostly recovered when a high current was applied and then a low current was applied again, the evaluation target electrode was confirmed to have excellent capacity recovery characteristics and high reversibility. This indicates that a liquid electrolyte may be efficiently impregnated into the nanofiber current collector and electrode structure, and thus the mobility of lithium ions is high, and the electrical conductivity of the current collector itself is also excellent to quickly transfer electrons.

Lastly, the capacity retention rate for the LFP-Li half-cell was examined, and the results are shown in FIG. 9. An initial discharge capacity of 126.8 mAh/g was measured by first discharging at a current rate of 1.0 C, a discharge capacity of 115.3 mAh/g was measured after 500 cycles, and a discharge capacity of 93.2 mAh/g was measured after 1000 cycles. That is, after 500 cycles, a capacity retention rate of 89.8%, and after 1000 cycles, a capacity retention rate of 73.5% were shown, and in the case of the electrode using the current collector of the present disclosure, it indicates that excellent capacity retention may be achieved due to stability of the current collector itself, low reactivity to an electrolyte, and low resistance and high electrical conductivity of the current collector.

Based on the above results, it is confirmed that the current collector of the present disclosure may serve well as a current collector of a stretchable lithium secondary battery.

The present disclosure may provide a current collector of a lithium secondary battery, which has excellent electrical conductivity, high stretch, and flexibility, and thus is used in stretchable and flexible electronic devices.

In addition, the current collector of the present disclosure has excellent structural and electrochemical stability and is lightweight to stably provide excellent performance of a lithium secondary battery and increase energy density.

In addition to the effects described above, specific effects of the present disclosure have been described in the above detailed description of the embodiments of the present disclosure.

Although the stretchable current collector and lithium secondary battery including the same have been described with reference to the specific embodiments, they are not limited thereto. Therefore, it will be readily understood by those skilled in the art that various modifications and changes can be made thereto without departing from the spirit and scope of the present disclosure defined by the appended claims.

What is claimed is:

1. A current collector formed of nanofiber, wherein the nanofiber comprises:
PEDOT:PSS;
a conductive dopant.

2. The current collector of claim 1, wherein the nanofiber is porous.

3. The current collector of claim 1, wherein the nanofiber has an average diameter of 50 μm to 300 μm.

4. The current collector of claim 1, wherein the nanofiber comprises at least one polymer selected from the group consisting of polyacrylonitrile, polyethylene oxide, polyvinylpyrrolidone, polyacrylamide, polyetheramide, polymethylmethacrylate, polycarbonate, polyurethane, polyvinyl chloride, polyethylene terephthalate, polyamide, polysulfone, polyether sulfone, polyphenylene sulfone, polyvinyl acetate, polyacrylic acid, polyvinyl alcohol, polyvinylidene fluoride, polyimide, polystyrene, polycarpolactone, polycaprolactam, polylactic acid, polylacticcoglycolic acid, polyhydroxyalkanoate, collagen, gelatin, chitosan, chitin, cellulose, hydroxyethyl cellulose, methyl cellulose, and ethyl cellulose.

5. The current collector of claim 1, wherein the conductive dopant is at least one selected from the group consisting of dimethyl sulfoxide (DMSO), dimethylformamide (DMF), ethylene glycol (EG), glycerol, and sorbitol.

6. A lithium secondary battery electrode comprising:
the current collector of claim 1; and
a positive electrode active material or a negative electrode active material, which is formed on a surface of the current collector.

7. The lithium secondary battery electrode of claim 6, wherein the positive electrode active material comprises at least one selected from the group consisting of lithium-cobalt-based oxide, sodium-cobalt-based oxide, lithium-manganese-based oxide, sodium-manganese-based oxide, lithium-nickel-manganese-based oxide, sodium-nickel-based oxide, lithium-manganese-cobalt-based oxide, sodium-manganese-cobalt-based oxide, lithium-nickel-manganese-cobalt-based oxide, sodium-nickel-manganese-cobalt-based oxide, lithium-nickel-cobalt-aluminum-based oxide, sodium-nickel-cobalt-based oxide, lithium-nickel-cobalt-manganese-aluminum-based oxide, sodium-nickel-cobalt-manganese-aluminum oxide, lithium iron phosphate oxide, sodium iron phosphate oxide, a lithium-sulfur compound, and lithium titanate.

8. The lithium secondary battery electrode of claim 6, wherein the negative electrode active material comprises at least one selected from the group consisting of lithium metal, a carbon material capable of reversibly intercalating/deintercalating lithium ions, metals or alloys of lithium and these metals, a metal composite oxide, a material which may be doped and undoped with lithium, and a transition metal oxide.

9. A lithium secondary battery comprising:
the electrode of claim 6;
a separator; and
an electrolyte.

10. A method of preparing a current collector, the method comprising:
adding a PEDOT:PSS solution to a polymer polymerization solution to obtain an electro-spinning solution (S1);
electro-spinning the electro-spinning solution to obtain nanofiber (S2);
doping the nanofiber with a conductive dopant (S3); and
heat-treating the nanofiber obtained from the process of (S2) (S4).
